(19) United States
(12) Patent Application Publication
(10) Pub. No.: US 2003/0132996 A1
(43) Pub. Date: Jul. 17, 2003

(54) Image formation method and image formation apparatus

(75) Inventor: Keiichi Adachi, Shizuoka (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/274,235

(22) Filed: Oct. 18, 2002

(30) Foreign Application Priority Data
Oct. 19, 2001 (JP) P. 2001-322586
Oct. 19, 2001 (JP) P. 2001-322587

(51) Int. Cl. B41J 2/01

(52) U.S. Cl. 347/102

(57) ABSTRACT

An image formation method for forming an image on a record material, the method comprises at least a record material loading step of loading a record material; an image creating step of creating an image onto the record material, and a heat fixing step of heating and fixing the record material with the image created thereon, the heat fixing step comprising first fixing step of heating the record material created the image in non-contact and a second fixing step of applying pressure at the same time as heating, wherein the heat fixing step further comprises a thermal interference prevention member providing step providing a thermal interference prevention member for preventing thermal interference between the first and second fixing steps or an output at the heat fixing time changed once or more in the first fixing step.

### BACKGROUND OF THE INVENTION

This invention relates to a fuser for uniformly fixing an image formed on a record material such as a record sheet made of paper, resin, etc., or a printing plate regardless of the type or the size of the record material in an image formation apparatus such as an electrophotographic image formation apparatus or an ink jet image formation apparatus.

A heat fixing art is widely used for a printer, a facsimile, a plate maker, etc., using an art of electrophotography, ionography, ink jet, etc., for externally creating an image to a record material. For example, in an electrophotographic copier, a drum-like photoconductor is charged and is exposed to light for forming an electrostatic latent image and the electrostatic latent image is developed in dry or wet toner and is transferred to record paper and then is heated and fixed, whereby an image is formed. With ionography, an ion emission head is used to form an electrostatic latent image like an image on a record medium having a charge holding capability and the electrostatic latent image is developed in dry or wet toner and then is heated and fixed, whereby an image is formed.

On the other hand, in an ink jet printer, it is common practice to jet ink onto record paper from a record head and naturally dry it for forming an image without fixing. However, in an ink jet printer using wax ink, it is hard to impregnate a record medium with ink and thus heat fixing is performed to ensure image adhesion to the record medium.

In recent years, it has become necessary to promote ink drying because of improvement in the print speed of the ink jet art, and a measure for applying UV light after drawing in UV ink, promoting drying an ink solvent by a heater, etc., or the like has been implemented.

On the other hand, colorant fine particles in ink are coated with resin, etc., to satisfy requirements of light resistance or hue, in which case image fixing similar to that of an electrophotographic copier becomes necessary and heat fixing is used suitably.

Further, in addition to directly printing on a record sheet as a record medium of a printer, a facsimile, etc., as described above, the heat fixing art is also used for the purpose of improving printing resistance in a system for making a printing plate used for printing.

In the above-mentioned heat fixing apparatus, usually a heat roller having a heat source is used singly for fixing an image on a record material created externally. However, to provide a sufficient fixing property in a short time for the heat roller to nip a record medium, the heat roller needs to be held at a high temperature for fixing. Thus, degradation of the heat roller is remarkable and has a short life. In recent years, to meet the requirement for speeding up image formation, it has also become necessary to fix in a shorter time in the heat fixing apparatus, in which case the above-mentioned requirement for the heat roller becomes stricter. To solve the problems, a method of previously raising the temperature of a record medium before fixing by the heat roller, thereby lowering the fixing temperature of the heat roller for prolonging the life of the heat roller and fixing in a short time is known. A lamp heater, etc., is used as unit for previously raising the temperature of a record medium.

Although the load on the heat roller can be lightened by the heating unit such as a lamp heater, the heat of the heat roller is lost to a record material, leading to unstable image fixing; this is a problem. In the length direction (fixing direction), uniformity of temperature is impaired remarkably and image fixing is hindered.

As unit for dealing with the problems, unit for controlling heat generation of the lamp heater or the heat roller is also available, but control becomes complicated.

It is therefore an object of the invention to provide an image formation method and an image formation apparatus for making it possible to make uniform fixing temperature of a record material in fixing at high speed and being capable of forming a high-quality image simply, at low cost, and stably. A first problem to be solved by the invention will be discussed below by taking as an example the case where a lamp heater and a heat roller having a heat source are used in combination:

When an image is externally created onto a record material, the record material is transported to a fixing section. In the fixing section, the record material is heated by the lamp heater and is also pressurized and heated by the heat roller for fixing the image. However, the heat generated from the lamp heater is applied to the parts installed in the proximity of the lamp heater including the heat roller as well as the record material. Therefore, the temperature in the apparatus rises, hastening the degradation of the members in the proximity of the lamp heater and making the apparatus easily fail.

To provide a sufficient fixing property in a short time, it is necessary to bring the lamp heater and the heat roller close to each other and raise the fixing temperature efficiently. Thus, the lamp heater heats the heat roller equal to or more than the record material and the temperature of the heat roller rises exceeding the setup temperature. Since the heat roller is heated exceeding the setup temperature, the surface temperature of the heat roller held at the setup temperature until the lamp heater is turned on also rises with the passage of time from turning on the lamp heater and the fixing temperature rises at the fixing time of the record material. Therefore, if printing is performed on an electrophotographic copier, an ink jet printer, etc., temperature rise is comparatively small in the top part (first heated portion) shortly after the lamp is turned on, but the temperature rise is large particularly in the rear portion and excessive fixing causes problems of an image defect, deformation of the record material, etc.

Further, when consecutive printing is performed, the surface temperature of the heat roller further rises and the situation of the excessive fixing worsens.

As described above, the heat generated from the lamp heater is applied to the parts installed in the proximity of the lamp heater including the heat roller as well as the record material, inducing a failure. Among them, the heat roller is heated especially by the lamp heater. Thus, the temperature of the heat roller rises and the heat roller is degraded shortly. As the temperature of the heat roller rises, the rubber material of the heat roller is degraded at an increasing tempo and so-called “bursting into tears” phenomenon in which the monomer component and additive of the rubber material are eluted may occur. Thus, raising the temperature of the heat roller more than necessary must be avoided.

If printing is performed on an electrophotographic copier, an ink jet printer, etc., excessive fixing occurs particularly on a record material heated at a high temperature and an image defect or deformation of the record material is observed and in addition, the apparatus easily fails. In addition, if the fixing art is used for the plate maker using the art of electrophotography, inkjet, etc., excessive fixing also occurs in a part heated at a high temperature and problems of an image defect, a printing resistance failure, etc., occur in printed matter.

In addition, the invention relates to a compact fixing method and apparatus capable of stably fixing in a short time and having a long life. A second problem to be solved by the invention will be discussed below by taking as an example the case where a lamp heater and a heat roller having a heat source are used in combination:

When an image is externally created onto a record material, the record material is transported to a fixing section. In the fixing section, the record material is heated by the lamp heater and is also pressurized and heated by the heat roller for fixing the image.

When heating the record material is started, heat is diffused to the unheated rear portion of the record material. Thus, the fixing temperature lowers in the top portion and the heat becomes hard to escape in the rear portion and thus the fixing temperature rises. If fixing is performed at constant output, the fixing temperature is low in the top portion and becomes higher toward the rear portion.

Just after the record material is heated, particularly the fixing temperature of the top portion lowers and the temperature uniformity is remarkably impaired in the length direction (fixing direction) and the fixing is obstructed. That is, in the top portion of the record material, the temperature lowers and a fixing failure occurs. If the art of an electrophotographic copier, an ink jet printer, etc., is used to print, an image defect of a character chip, highlight leap, etc., occurs in the top portion of the record material at low heating temperature. In addition, if the fixing art is used for the plate maker using the art of electrophotography, ink jet, etc., a fixing failure also occurs in the top portion of the record material and problems of an image defect of a character chip, highlight leap, etc., degradation of printing resistance, and the like occur.

To eliminate the fixing failure in the top portion of the record material, if output of the lamp heater, the heat roller is simply raised with constant output intact, the fixing temperature rises in the rear portion and excessive fixing causes an image defect and deformation of the record material and in addition, the apparatus is made easily to fail.

### SUMMARY OF THE INVENTION

It is therefore a first object of the invention to make it possible to make uniform fixing temperature of a record material in fixing at high speed and form a high-quality image simply, at low cost, and stably, as described above.

In addition to this, it is therefore a second object of the invention to make it possible to make uniform fixing temperature of a record material in fixing at high speed and form a high-quality image simply, at low cost, and stably.

To achieve the first and second objects, according to the invention, there is provided an image formation method for forming an image on a record material, the method comprising: at least a record material loading step of loading a record material; an image creating step of creating an image onto the record material; and a heat fixing step of heating and fixing the record material with the image created thereon, the heat fixing step comprising first fixing step of heating the record material created the image in non-contact and a second fixing step of applying pressure at the same time as heating, wherein the heat fixing step further comprises a thermal interference prevention member providing step providing a thermal interference prevention member for preventing thermal interference between the first and second fixing steps or an output at the heat fixing time changed once or more in the first fixing step.

According to the image forming method, it is preferable that the thermal interference prevention member is provided for preventing thermal interference between the first and second fixing steps.

According to the image forming method, it is preferable that a baffle board is placed between the first and second fixing steps as the thermal interference prevention member.

According to the image forming method, it is preferable that a heat fixing member used in the first fixing step is provided with a light gathering member for heating and fixing the record material.

According to the image forming method, it is preferable that the output at the heat fixing time is changed once or more in the first fixing step.

According to the image forming method, it is preferable that the output is maximized at the heat fixing time when the heat fixing is started and/or minimized at the heat fixing termination time.

To achieve the first and second objects, according to the invention, there is provided an image formation apparatus comprising: a record material loading unit for loading a record material; an image creating unit for creating an image onto the record material loaded by the record material loading unit; and a heat fixing unit for heating and fixing the record material created the image by the image creating unit, the heat fixing unit comprising a first fixing unit for heating the record material created the image in non-contact and a second fixing unit for further applying pressure at the same time as heating the record material heated by the first fixing unit, wherein a thermal interference prevention unit is provided for preventing thermal interference between the first fixing unit and the second fixing unit or an output control mechanism for changing output at the heat fixing time once or more is provided in the first fixing unit.

According to the image forming apparatus, it is preferable that the thermal interference prevention unit is provided for preventing thermal interference between the first fixing unit and the second fixing unit.

According to the image forming apparatus, it is preferable that a baffle board is placed between the first fixing unit and the second fixing unit as the thermal interference prevention unit.

According to the image forming apparatus, it is preferable that the first fixing unit is a lamp heater and the second fixing unit is a heat roller.

According to the image forming apparatus, it is preferable that a light gathering member is provided in the first fixing unit.

According to the image forming apparatus, it is preferable that the output control mechanism for changing output at the heat fixing time once or more is provided in the first fixing unit.

According to the image forming apparatus, it is preferable that the output control mechanism for controlling the first fixing unit maximizes the output at the heat fixing time when the heat fixing is started and/or minimizes the output at the heat fixing termination time.

### BRIEF DESCRIPTION OF THE DRAWINGS

FIG. 1 is a drawing to show an electrophotographic copier installing a fuser of the invention;

FIGS. 2A and 2B are drawings to show a fuser according to the invention; FIG. 2A is a side view of the fuser and FIG. 2B is a schematic representation of a lamp heater ((i) is a front view and (ii) is a side view);

FIG. 3 is a drawing to show an application example of the fuser of the invention to an ink jet printer;

FIG. 4 is a drawing to show an example of a plate maker comprising the fuser of the invention; and

FIG. 5 is a drawing to show an application example of the fuser of the invention to toner jet.

### DETAILED DESCRIPTION OF THE PREFERRED EMBODIMENTS

An embodiment of the invention will be discussed in detail.

As an image formation method according to the invention, any image formation method can be used if it is an image formation method of externally creating an image to a record material using electrophotography, ionography, ink jet, or the like, and any of the techniques can also be applied or the techniques can also be used in combination suitably. Thus, the invention makes it possible to provide a clear, high-quality image by inexpensive and simple unit.

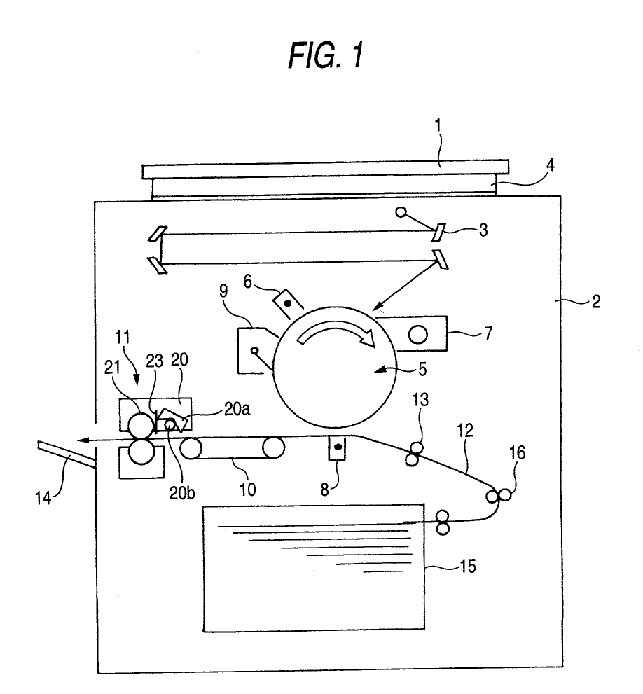

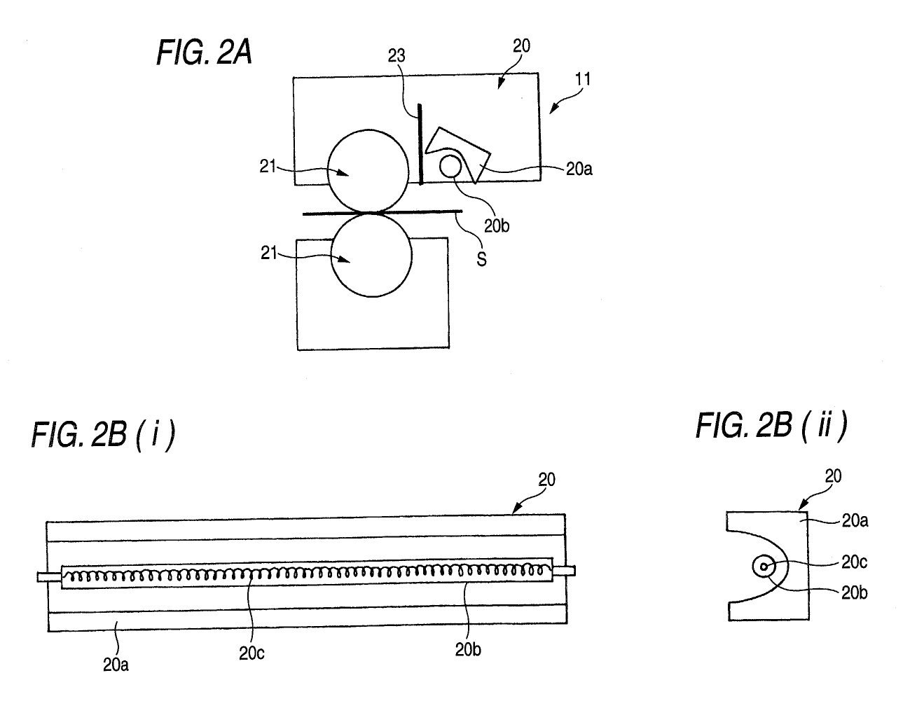

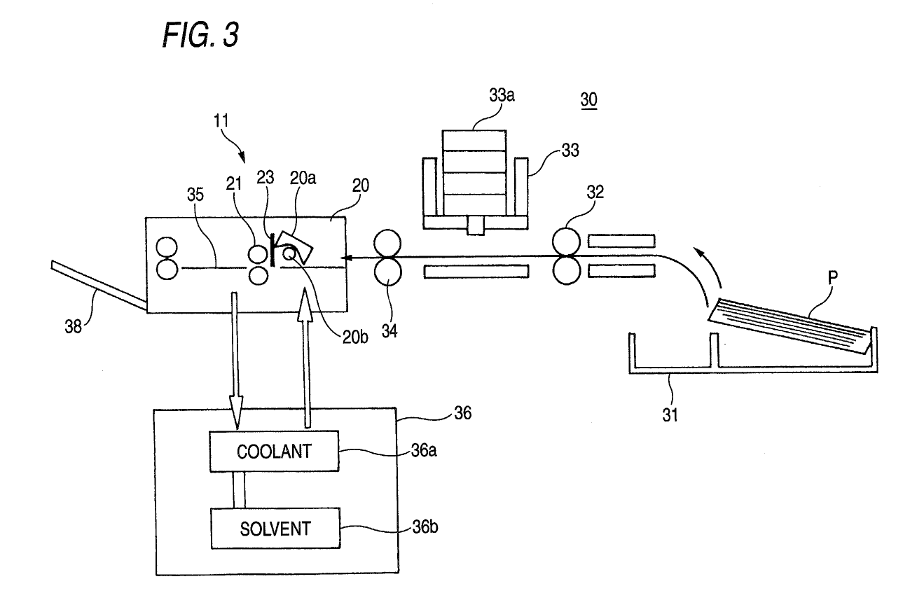

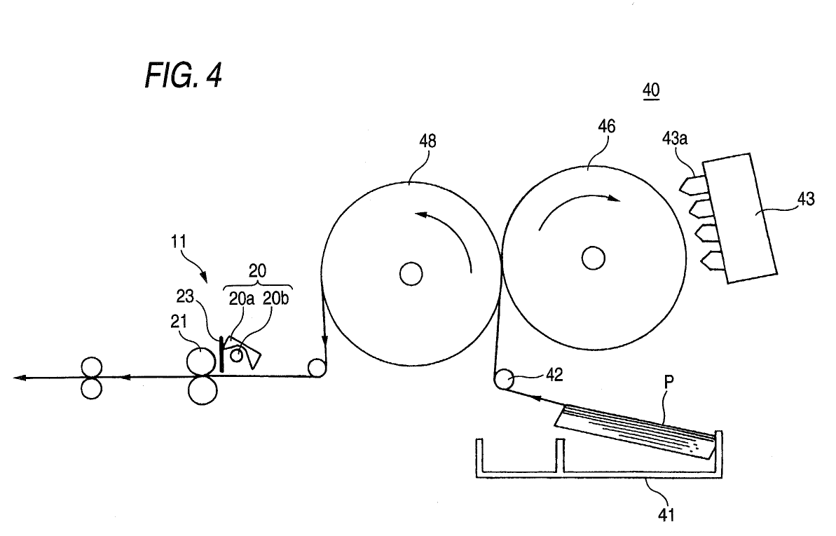

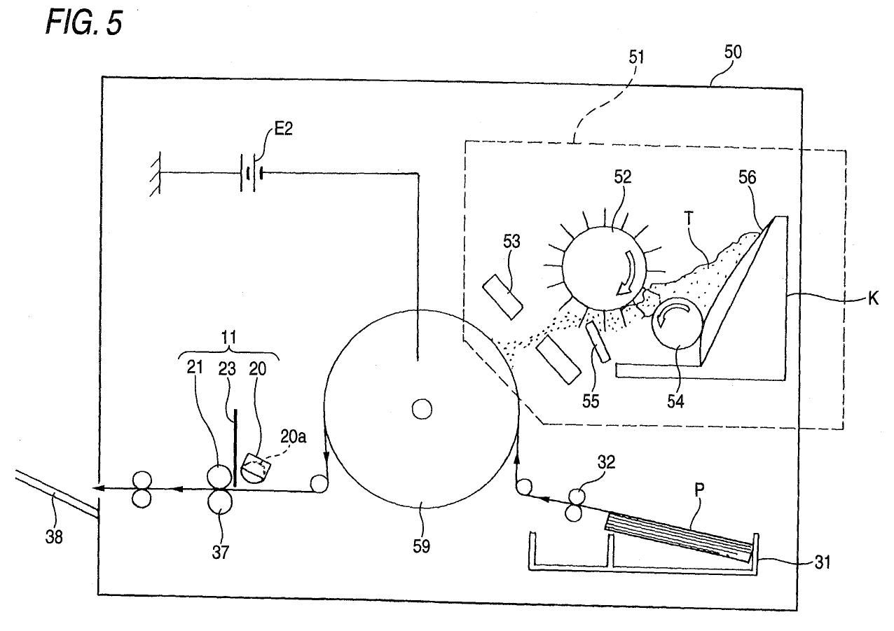

Next, a configuration example of an image formation apparatus used for executing the image formation method of the invention is shown. FIG. 1 is a drawing to show an application example of the invention to an electrophotographic copier. FIGS. 2A and 2B are drawings to show a fuser according to the invention; FIG. 2A is a side view of the fuser and FIG. 2B is a schematic representation of a lamp heater ((i) is a front view and (ii) is a side view). FIG. 3 is a drawing to show an application example of the invention to an ink jet printer. FIG. 4 is a drawing to show an application example of the invention to a plate maker using ink jet. FIG. 5 is a drawing to show an application example of the invention to toner jet.

To begin with, an application example of the invention to an electrophotographic copier will be discussed with reference to FIG. 1.

FIG. 1 is a sectional view of an electrophotographic copier. An image formation apparatus 1 as the electrophotographic copier comprises a platen 4 on an apparatus main unit 2 like a general electrophotographic copier. It is a mechanism for reading an image of an original set on the platen 4 by a scanner 3 and giving an image pattern responsive to the original image to a photoconductor drum 5 as a light exposure pattern. The photoconductor drum 5 is surrounded by an image formation mechanism using general electrophotography. That is, first the surface of the photoconductor drum 5 is uniformly charged by a charging corotron 6 and an original read pattern is scanned and is exposed to light for forming an electrostatic latent image. Next, toner is supplied from a developing unit 7 and is deposited on the electrostatic latent image to form a toner image responsive to the electrostatic latent image. Here, dry developing is described, but the developing method is not limited to the dry developing, of course, and wet developing may be used.

A transfer unit 8 transfers the toner image formed on the photoconductor drum 5 onto a record material by an electric field force. Here, the record material is supplied from a paper feed section 15, but the supply method is not limited to it; for example, a paper feed roll may be provided for supplying the remaining toner, etc., on the surface of the photoconductor drum 5 is removed by a cleaning unit 9.

An alignment unit 13 for aligning paper with an end part of a paper transport passage 12 is loaded in a section immediately preceding an image transfer section. That is, the alignment operation of paper supplied from a paper feed tray is performed and the paper is delivered to the image transfer section at a predetermined timing matching the toner image formed on the photoconductor drum 5.

The paper to which the toner image is transferred is transported to a fuser 11, and enters a fixing section.

The fixing section comprises a near infrared lamp heater 20 and a heat roller 21 for pressurizing and heating copy paper. The fixing section is provided with the lamp heater 20 for preheating paper to a predetermined surface temperature upstream from the heat roller 21. Paper is preheated to any desired temperature before fixing by the heat roller 21, whereby the need for heating the record material by the heat roller 21 only is eliminated and thus the setup temperature of the heat roller 21 can be lowered. In the lamp heater 20, if the setup temperature of the heat roller 21 is raised, although it depends on the material of the heat roller 21, the rubber material of the heat roller 21 is degraded at an increasing tempo and so-called “bursting into tears” phenomenon in which the monomer component and additive of the rubber material are eluted may occur. In contrast, the lamp heater 20 is used in combination, whereby the need for setting the heat roller 21 to a high temperature is eliminated, durability of the heat roller 21 is enhanced, and the “bursting into tears” problem is eliminated.

In addition, when the heat roller 21 is at a high temperature, a bearing of the roller may be degraded; however, as the heat roller 21 and the lamp heater 20 are used in combination, the setup temperature is lowered and degradation of the bearing can be prevented. Preferably, the temperature of the heat roller 21 is 30° C. to 250° C. to provide a fixing property, more preferably 60° C. to 200° C. Further, the record material is preheated before fixing by the heat roller 21, whereby the fixing time can be shortened.

It is desirable that the time to fixing by the heat roller 21 from the lamp heater 20 should be defined so that the heating effect of the lamp heater 20 also remains at the fixing time of the heat roller 21, and the time difference between heating of the lamp heater 20 and heating of the heat roller 21 is within 7 seconds.

Here, the lamp heater 20 is used as the first fixing step and the heat roller 21 is used as the second fixing step, but any can be applied in the first fixing step if it heats a record material in non-contact. For example, any of various lamp heaters such as the above-described near infrared lamp heater and a far infrared lamp heater and radiation heaters such as a ceramic heater can be applied.

The heat roller 21 is used in the second fixing step, but any can be applied if it can apply pressure at the same time as heating. For example, a belt fuser, etc., can also be used suitably.

Further, in addition to the first fixing unit and the second fixing unit, it is also possible to provide fixing unit capable of heating and pressurizing whenever necessary. For example, the number of heating unit may be increased; two or more heat rollers or two or more lamp heaters may be used.

After the paper is inserted into the fixing section, the paper to which the toner image is transferred is heated for raising the paper temperature by the lamp heater 20. After this, the paper is pressurized while being heated by the heat roller 21, whereby the toner on the paper is softened or fused and is pushed and penetrated into the paper to promote the fixing property. Here, the case of heating, pressurizing, and fixing by the heat roller 21 after heating by the lamp heater 20 has been described. However, if the lamp heater 20 is used after treatment by the heat roller 21, a better fixing property than that when the heat roller 21 is used singly can be provided although the effect lessens.

Usually, Si rubber is often used as the material of the heat roller 21, but a rubber roller of fluorine base or NBR base rubber may be used and any other material may be used. The rubber roller surface may be coated with a resin sheet of a predetermined thickness (for example, 50 to 500 μm). Here, the nip pressure of the heat roller 21 is 0.05 MPa to 250 MPa to provide a sufficient fixing property, more preferably 0.1 MPa to 20 MPa.

A thermal interference prevention member 23 is placed between the lamp heater 20 and the heat roller 21 so as to shield a heat ray from the lamp heater 20 to the heat roller 21. Basically, a material which does not become deformed by heat is effective as the material of the thermal interference prevention member 23; a material of an alloy, plastic, ceramic, glass, Bakelite, etc., as well as metal, light metal of iron, steel, brass, gold, silver, lead, aluminum, nickel, tin, copper, SUS, etc., is used.

The surface temperature of the heat roller 21 is made uniform. Based on the surface temperature found by unit for detecting the surface temperature (not shown), output is controlled for holding the surface temperature constant by changing the voltage applying time. However, the control method is not limited to it and unit for changing the voltage applied to a heating element is also available. Here, the surface temperature is detected and temperature control is performed, but the necessary voltage supply amount may be previously calculated and then changed without detecting the temperature for performing temperature control.

For example, in the fixing section 11, heating of the lamp heater 20 and heating and pressurizing of the heat roller 21 are performed. Output of the lamp heater 20 can be modulated by lamp heater output control unit (not shown) while the record material is being fixed. The output of the lamp heater 20 is set so as to reach the maximum just after the record material is inserted into the fuser. The output of the lamp heater to be modulated varies depending on the structure of the apparatus. Preferably, the output of the lamp heater 20 in the top portion is 103% to 300% of average output at the fixing time and more preferably 105% to 200%. Preferably, the output of the lamp heater 20 in the rear end portion is 15% to 97% of average output at the fixing time and more preferably 25% to 95%.

The number of times the output of the lamp heater 20 is modulated is at least one. The number of times the output of the lamp heater 20 is to be modulated is determined by the size of the record material and the temperature latitude of the material used. Here, if the record material size is small such as A5 or B5, the output of the lamp heater 20 may be modulated about once; if the record material size is a large size of B4 or more, the number of times the output of the lamp heater 20 is to be modulated may need to be increased. If the available temperature range relative to the fixing temperature of the record material used, the material containing resin, etc., externally deposited on the record material is narrow, the number of modulation times needs to be increased for making uniform temperature more accurately. To control the temperature accurately, the method of stepwise increasing the number of times as described above is also available; the output of the lamp heater 20 may be changed continuously. Further, output control may be performed while the amount corresponding to the temperature on the record material is deteted.

FIGS. 2A and 2B show examples of using an infrared heater as the lamp heater 20.

In FIGS. 2A and 2B, numeral 20b denotes an infrared heater. A reflecting plate 20a having a light gathering property is installed at a symmetric position with a record material S with respect to the infrared heater 20b, and a heat ray emitted from a heating element winding 20c of the infrared heater 20b is gathered on the record material S. The shape and material of the reflecting plate 20a may be any if a light gathering property is provided; adjustment may be made so as to gather the heat ray on the record material S. The light gathering member can be made of metal, light metal, or an alloy of iron, steel, brass, gold, silver, lead, aluminum, nickel, tin, copper, SUS, etc., or can be plated therewith. In addition, it can be made of ceramic (containing ceramic coated with plating) or heat-resistant plastic coated with plating. The reflecting plate having a light gathering property is taken as an example, but light may be gathered using a member of a lens, etc. An example of the unit of the lamp heater 20 is shown in FIG. 2B. FIG. 2B is a schematic representation of the lamp heater. In front view (i) and side view (ii), the infrared heater 20b is shaped like an elongated cylinder, the heating element winding 20c is placed on the center line of the infrared heater 20b, the reflecting plate 20a having a light gathering property is installed so as to surround the infrared heater 20b, and a heat ray emitted from the infrared heater 20b is reflected on the reflecting plate 20a and is gathered on the record material S (FIG. 2A).

Referring again to FIG. 1, the record material S (copy paper) thus undergoing the fixing processing is then ejected to an ejection tray 14. To supply paper to the image transfer section of the main unit 2 of the image formation apparatus 1, the paper feed section 15 is placed in the lower part of the apparatus main unit 2 and a transport roller unit 16 is used to deliver paper. Although the paper sizes available with the apparatus are A3, A3, A5, B4, and B5, the fixing art is effective regardless of the paper size; it is effective not only for large sizes of A1, A2, B1, B2, etc., but also for A3 w size, postcard, and envelope printing.

The described image formation method can be applied to both dry toner developing and wet toner developing. To apply the image formation method to wet developing, to remove the solvent evaporated in the machine, hermeticity in the machine is enhanced and a mechanism for removing the solvent is provided. As a solvent collection method, for example, a mechanism for sucking air in the machine containing the solvent and cooling it, thereby liquefying is placed. However, the solvent collection method is not limited to it and any method such as a method of using a solvent adsorbent to adsorb the solvent can be applied if it is a method capable of separating the solvent.

In the above-described embodiment, electrophotography is applied as image creating unit, but the invention can be applied not only to electrophotography, but also to a printer, a facsimile, a plate maker, etc., using an art of ionography, ink jet, etc.

Particularly, in the ink jet art, the image formation method of the invention can be used regardless of the ink ejection method or the ink type; for example, it can be used regardless of the ejection method such as thermal, piezo, or electrostatic, and it can also be used as for a method provided by combining them appropriately.

### EXAMPLES 1,2 and 3

Next, the invention was applied to the above-described copier and the lamp heater 20 and the heat roller 21 were adjusted so that the top of a record material can be heated at about 120° C., and heat fixing was conducted. Before heat roller 21 (manufactured by Hitachi Kinzoku (Kabu)) fixing, the record material was heated and the temperature thereof was raised to 100° C. by the near infrared lamp heater 20. The fixing conditions were as follows: The heat roller 21 surface temperature was 150° C., the record material transport speed was 15 mm/sec, and the application pressure (nip pressure) of the heat roller 21 to the record material was 0.8 MPa.

TABLE 1

| | | Lamp heater | | Reproducibility | |
|---|---|---|---|---|---|
| | Interference | light | Heat roller | of | |
| Experiment | prevention | gathering | temperature | post-fixed | Apparatus |
| No. | member | member | ° C. | image | trouble part |
| Example 1 | Included | Included | 150 | Good | None |
| Example 2 | None | Included | 150 | Good | None |
| Example 3 | Included | None | 150 | Good | None |
| Control | None | None | 230 | No good | Heat roller |
| example 1 | | | | (excessive | Pressurizing |
| | | | | fixing) | roller |
| | | | | | Transport |
| | | | | | system, etc. |

The record material surface temperature and image reproducibility when the thermal interference prevention member (baffle board) 23 and the light gathering member 20a were used are examined based on Table 1. Output adjustments of the lamp heater 20 and the heat roller 21 were made and in example 1, the interference prevention member and the light gathering member (unit with reflection plate) of the lamp heater 20 were provided and printing was performed on 10 sheets consecutively.

As a result, the fixing temperature distribution on the record material was uniform and good image reproduction was obtained. The heat roller temperature maintained the setup value and remained at 150° C. Trouble on the apparatus did not occur.

On the other, in example 2, the interference prevention member 23 was removed and the light gathering member 20a of the lamp heater 20 was attached and printing was performed on 10 sheets consecutively. As a result, the fixing temperature distribution on the record material was uniform and good image reproduction was obtained. The heat roller 21 temperature maintained the setup value and remained at 150° C. Trouble on the apparatus did not occur.

In example 3, the light gathering member 20a of the lamp heater 20 was removed and the thermal interference prevention member (baffle board) 23 was attached and printing was performed on 10 sheets consecutively. As a result, the fixing temperature distribution on the record material was uniform and good image reproduction was obtained. The heat roller 21 temperature maintained the setup value and remained at 150° C. Trouble on the apparatus did not occur.

On the other hand, in control example 1, both the thermal interference prevention member (baffle board) 23 and the light gathering member 20a of the lamp heater 20 were removed and printing was performed on 10 sheets consecutively. As a result, in addition to deformation of the record material, an image defect caused by hot offset was observed. During the printing, the heat roller 21 temperature exceeded the setup value and unusual noise was produced from the bearings of the heat roller 21 and the pressurizing roller and a rotation failure occurred. An anomaly also occurred in the transport system.

As described above, the baffle board 23 and the light gathering member 20a of the lamp heater 20 are provided, whereby a structure can be provided for making it possible to make the fixing temperatures uniform, provide printed matter excellent in image reproducibility, and further prevent apparatus trouble from occurring.

### EXAMPLES 4 and 5

TABLE 2

| | | Record material | | | |
|---|---|---|---|---|---|
| | Number of | temperature ° C. | | | Apparatus |
| Experiment | modulation | Top | Rear end | Image | trouble |
| No. | times | portion | portion | quality | part |
| Example 4 | 2 | 119 | 122 | Good | None |
| Example 5 | 1 | 114 | 123 | Good | None |
| Control | 0 | 87 | 123 | No good | None |
| example 2 | | | | | |
| Control | 0 | 122 | 146 | No good | Heat roller |
| example 3 | | | | | bearing |
| | | | | | part |

The record material surface temperature and image reproducibility when lamp heater output control mechanism was provided are examined based on Table 2. Output adjustments of the lamp heater 20 and the heat roller 21 were made and in example 4, the output control mechanism of the lamp heater 20 was provided, output modulation was conducted twice, and printing was performed. As a result, the fixing temperature distribution on the record material was uniform and good image reproduction was obtained. Trouble on the apparatus did not occur.

On the other, in example 5, the output control mechanism of the lamp heater 20 was provided, output modulation was conducted once, and printing was performed. As a result, the uniformity of the fixing temperature distribution on the record material was inferior to that in example 4, but good image reproduction was obtained. The heat roller 21 temperature maintained the setup value and remained at 150° C. Trouble on the apparatus did not occur.

On the other hand, in control example 2, the output control mechanism of the lamp heater 20 was not provided, output modulation was not conducted, and printing was performed. As a result, the fixing temperature distribution on the record material became non-uniform and the temperature lowered in the tip portion. On the obtained printed matter, character chip and patchy image caused by a fixing failure were observed in the top portion of the fixing (fixing start position). Trouble on the apparatus did not occur.

In control example 3, the output control mechanism of the lamp heater 20 was not provided, output modulation was not conducted, only output of the lamp heater is raised, and printing was performed. As a result, the fixing temperature distribution on the record material remained non-uniform and the temperature rose in the rear end portion. On the obtained printed matter, hot offset and deformation of the record material (paper) caused by excessive fixing were observed in the rear end portion of the fixing (fixing termination position). Trouble on the apparatus did not occur. When printing was performed consecutively, the temperature in the apparatus rose and an unusual noise was heard from the bearing part of the heat roller.

As described above, the output control mechanism of the lamp heater is provided and output modulation is conducted, whereby a structure can be provided for making it possible to make the fixing temperatures uniform, provide printed matter excellent in image reproducibility, and further prevent apparatus trouble from occurring.

### EXAMPLES 6,7 and 8

Next, FIG. 3 shows an application example of the invention to an ink jet printer.

FIG. 3 shows the cross section of an image record apparatus having an ink jet record apparatus 30 as image creating unit. A cassette 31 containing a record material P of a resin sheet is placed in the bottom of the ink jet record apparatus 30. A transport roller pair 32 and a carriage 33 on which a record head 33a is mounted are placed downstream in a record material transport direction. A share-mode 500-channel piezo ink jet unit (XaarJet500S manufactured by Xaar) was used as the record head 33a and oil ink (manufactured by Xaar) was used. The drawing resolution was 720 dpi and dots were changed in size in eight steps for controlling gradation.

Dust is removed from the record material P before the record material P is transported to and loaded at the drawing position by the transport roller 32 and an image is created by the ink jet record apparatus. Here, the transport roller 32 is previously given adhesion, whereby dust is removed. However, a gum roller for removing dust may be provided aside from the transport roller 32. As the dust removing method, a method of attracting surface dust by the gum roller is adopted, but the method is not limited to it; for example, a method of removing dust by an airflow, etc., is also available.

Next, the record material P is transported to a point below the record head 33a and drawing is performed. On the other hand, an ejection roller pair 34 and the transport roller pair 32 before and after the drawing step are operated in conjunction with each other and the ejection roller pair 34 is set to a little larger rotation speed than that of the transport roller pair 32 for providing the record material with a proper tension. While the record head 33a is moved in a vertical direction to the paper plane by the carriage 33, it ejects ink for drawing an image responsive to an image signal. At this time, image drawing of a given width is performed on the record material P. That is, whenever one line is drawn on the record material P, the record material P is transported one line by the transport roller pair 32 and another line is drawn. Such operation is repeated and the record material P is transported to a heat fixing section 11 in sequence by the ejection roller pair 34. Upon completion of the drawing, fixing is performed by lamp heater 20 and heat roller 21 in the heat fixing section 11 and then the record material P is ejected to a paper ejection tray 38 from which the record material P is taken out.

A heat fixing transport passage 35 has a smooth surface shape for allowing smooth transport at the fixing time. The record material P ejected from the record section (33, 33a) is smoothly transported into the heat fixing section 11. Baffle board 23 for thermal interference prevention is placed according to the invention between the heat roller 21 and the lamp heater 20, whereby the fixing temperature can be stabilized and stable fixing property can be provided. The lamp heater unit is provided with a light gathering property and the record material can be fixed efficiently and the effect on any other member than the record material is suppressed.

In the heat fixing section 11, heating of the lamp heater 20 is performed before execution of heating, pressurizing, and fixing of the heat roller 21. Output of the lamp heater 20 is modulated by output control mechanism (not shown) from the fixing start to the fixing termination. Accordingly, the fixing temperature can be stabilized and stable fixing property can be provided.

The solvent in ink is vaporized and fills the machine by the drawing operation and the fixing operation. Then, hermeticity is enhanced in the portion enclosed by the dashed line and a solvent collection mechanism 36 is provided for collecting the vaporized solvent in the machine. As the collection method, air in the machine is sent to the solvent collection mechanism 36 and is cooled in a coolant cooling section 36a, whereby the solvent is liquefied and is collected in a solvent collection section 36b and air from which the solvent is separated is sent back to the inside of the machine. Accordingly, the solvent vapor occurring in the machine is removed, the inside of the machine is not polluted with the solvent vapor, and an offensive smell when the solvent vapor is diffused to the outside of the machine is not produced. The solvent vapor is hermetically sealed in the heat fixing section, but the heat fixing section may be contained and the hermetically sealed range is not limited to it. For example, the range containing the heat fixing section and the drawing section (record head) may be hermetically sealed for removing the solvent.

The method of drawing directly on the record material P and fixing has been described, but the image formation method is not limited to it and using a transfer drum, an image formed on a drawing drum may be transferred to the record material. To supply the record material P, any other than the cassette maybe used; for example, the record material P maybe supplied with a roll.

According to the invention, an image is made firm by heating by heat roller (manufactured by Hitachi Kinzoku (Kabu)) fixing. Before heat roller fixing, the record material was heated and the temperature thereof was raised to 60° C. by the near infrared lamp heater. The fixing conditions were as follows: The heat roller temperature was 130° C., the record material transport speed was 15 mm/sec, and the application pressure (nip pressure) of the heat roller 21 to the record material was 0.6 MPa.

TABLE 3

| | | | Maximum | | |
|---|---|---|---|---|---|
| | Baffle board | Lamp heater | arrival | Reproducibility | |
| | for | light | temperature | of | |
| Experiment | interference | gathering | ° C. of heat | post-fixed | Apparatus |
| No. | prevention | member | roller | image | trouble part |
| Example 6 | Included | Included | 130 | Good | None |
| Example 7 | None | Included | 130 | Good | None |
| Example 8 | Included | None | 130 | Good | None |
| Control | None | None | 205 | No good | Heat roller |
| example 4 | | | | | Transport |
| | | | | | system, etc. |

The record material surface temperature and image reproducibility when the thermal interference prevention member and the light gathering member according to the invention were used are examined based on Table 3. Output adjustments of the lamp heater 20 and the heat roller 21 were made so that the temperature on the record material became about 100° C.

In example 6, the thermal interference prevention member (baffle board) 23 and the light gathering member (unit with reflection plate) 20a of the lamp heater 20 were provided and printing was performed on 20 sheets consecutively.

As a result, the fixing temperature distribution on the record material was uniform and good image reproduction was obtained. Trouble on the apparatus did not occur.

In example 7, the baffle board for interference prevention 23 was removed from example 4 and printing was performed on 20 sheets consecutively. As a result, the fixing temperature distribution on the record material was uniform and good image reproduction was obtained. Trouble on the apparatus did not occur.

In example 8, the light gathering member 20a of the lamp heater 20 was removed from example 4 and printing was performed on 20 sheets consecutively. As a result, the fixing temperature distribution on the record material was uniform and good image reproduction was obtained. Trouble on the apparatus did not occur.

In control example 4, both the thermal interference prevention member 23 and the light gathering member 20a of the lamp heater 20 were removed and printing was performed on 20 sheets consecutively. As a result, the temperature of the heat roller 21 reached 205° C. at the maximum and deformation of the record material and an image defect were observed.

During the printing, an unusual noise was produced from the bearing of the heat roller 21 and a rotation failure occurred. In addition, an anomaly also occurred in the transport system.

As described above, the baffle board for interference prevention 23 and the light gathering member 20a of the lamp heater 20 are provided, whereby a structure can be provided for making it possible to make the fixing temperatures uniform, provide printed matter excellent in image reproducibility, and further prevent apparatus trouble from occurring.

TABLE 4

| | | Record material temperature | | | |
|---|---|---|---|---|---|
| | Number of | ° C. | | | |
| | modulation | | Rear end | Image | Apparatus |
| Experiment No. | times | Top portion | portion | quality | trouble part |
| Example 9 | 2 | 110 | 113 | Good | None |
| Example 10 | 1 | 107 | 114 | Good | None |
| Control | 0 | 83 | 110 | No good | None |
| example 5 | | | | | |
| Control | 0 | 113 | 132 | No good | Transport |
| example 6 | | | | | system |

The record material surface temperature and image reproducibility when lamp heater output control mechanism according to the invention was provided are examined based on Table 4. Output adjustments of the lamp heater 20 and the heat roller 21 were made and in example 9, the output control mechanism of the lamp heater 20 was provided, output modulation was conducted twice, and printing was performed. As a result, the fixing temperature distribution on the record material was uniform and good image reproduction was obtained. Trouble on the apparatus did not occur.

On the other, in example 10, the output control mechanism of the lamp heater 20 was provided, output modulation was conducted once, and printing was performed. As a result, the uniformity of the fixing temperature distribution on the record material was inferior to that in example 9, but good image reproduction was obtained. The heat roller 21 temperature maintained the setup value and remained at 150° C. Trouble on the apparatus did not occur.

On the other hand, in control example 5, the output control mechanism of the lamp heater 20 was not provided, output modulation was not conducted, and printing was performed. As a result, the fixing temperature distribution on the record material became non-uniform and the temperature lowered in the tip portion. On the obtained printed matter, character chip and patchy image caused by a fixing failure were observed in the top portion of the fixing (fixing start position). Trouble on the apparatus did not occur.

In control example 6, the output control mechanism of the lamp heater 20 was not provided, output modulation was not conducted, only output of the lamp heater 20 is raised, and printing was performed. As a result, the fixing temperature distribution on the record material remained non-uniform and the temperature rose in the rear end portion. On the obtained printed matter, hot offset and deformation of the record material (paper) caused by excessive fixing were observed in the rear end portion of the fixing (fixing termination position). Trouble on the apparatus did not occur. When printing was performed consecutively, the temperature in the apparatus rose and an unusual noise was heard from the bearing part of the heat roller.

As described above, the output control mechanism of the lamp heater is provided and output modulation is conducted, whereby a structure can be provided for making it possible to make the fixing temperatures uniform, provide printed matter excellent in image reproducibility, and further prevent apparatus trouble from occurring.

### EXAMPLES 11,12 and 13

FIG. 4 shows a plate maker 40 comprising a transfer drum and a drawing drum.

A cassette 41 containing a record material P of a plate material is loaded in the bottom of the plate maker 40, and the record material P is transported to and loaded on a transfer drum 48 through a transport roller 42 downstream in a record material transport direction.

On the other hand, a record head 43a is placed in the proximity of the drawing drum 46. While the drawing drum 46 is rotated, ink is ejected onto the drawing drum 46 for forming an image. As the drawing drum 46 with the image formed thereon continues to rotate, ink formed like an image is moved to a press contact section with the transfer drum 48 and is transferred to the record material P on the drawing drum 46 in the press contact section.

The record material P to which the ink image is thus transferred is transported toward heat fixing section 11 and the image is fixed by lamp heater 20 and heat roller 21 in the heat fixing section 11. Baffle board 23 for thermal interference prevention is placed according to the invention between the heat roller 21 and the lamp heater 20, whereby the fixing temperature is stabilized and stable fixing property is provided.

In the heat fixing section 11, heating of the lamp heater 20 is performed before execution of heating, pressurizing, and fixing of the heat roller 21. Output of the lamp heater 20 is modulated by output control mechanism (not shown) from the fixing start to the fixing termination. Accordingly, the fixing temperature can be stabilized and stable fixing property can be given to the plate material.

The record head used here was a piezo ink jet unit (Colorio PM750C manufactured by Epson) and using oil ink manufactured by Xaar, drawing was conducted on the plate material. The following paper plate material provided with a hydrophilic image reception layer was used as the plate material:

The paper plate material was bond paper (100 g/m²) provided with a water-resistant layer consisting mainly of polyvinyl alcohol, SBR latex, kaolin, and melamine resin on both sides of bond paper. Further, image reception layer was placed on the support so that the following prepared fluid dispersion became 5 g/m² as the application amount after dry, thereby making the paper plate material:

Fluid dispersion A

| | |
|---|---|
| Gelatin (Wakou Jyunyaku first-class product) | 2 g |
| Colloidal silica (manufactured by Nissan Kagaku; Snowtex | 13 g |
| C, 20% water solution) | |
| Silica gel (manufactured by Fuji Silicia Kagaku; Cylicia | 5 g |
| #310) | |
| Hardening agent | 0.3 g |
| Distilled water | 67 g |

Preparation method With glass beads added, dispersing for 10 minutes with a paint shaker

The above-described piezo ink jet unit head was installed in the plate maker of the structure shown in FIG. 4 and gap was adjusted to 1.5 mm. Image data was transmitted to a calculation control section, 32 channels were used, the drawing drum 46 was rotated, ejection head was moved, and ink was ejected to the paper plate mounted on the drawing drum 46 for performing drawing. (Drawing resolution 720 dpi)

Further, according to the invention, an image was made firm by heating by heat roller 21 (manufactured by Hitachi Kinzoku (Kabu)) fixing and printing plate was prepared. Before heat roller 21 fixing, the record material was heated and the temperature thereof was raised to 0° C. by the near infrared lamp heater 20. The fixing conditions were as follows: The heat roller 21 temperature was 140° C., the record material transport speed was 7 mm/sec, and the application pressure (nip pressure) of the heat roller 21 to the record material was 0.3 MPa.

Then, the obtained printing plate was set in a printer, print ink and dampening water were given, a print ink image was transferred onto a blanket cylinder rotating together with a printing cylinder, and the print ink image on the blanket cylinder was transferred onto print coated paper passing through between the blanket cylinder and an impression cylinder for printing.

TABLE 5

| | | | Maximum | | |
|---|---|---|---|---|---|
| | | Lamp | arrival | Image | |
| | Baffle board | heater | temperature | reproducibility | |
| | for | light | ° C. | of | Apparatus |
| | interference | gathering | of heat | printed | trouble |
| Experiment No. | prevention | member | roller | matter | part |
| Example 11 | Included | Included | 140 | Good | None |
| Example 12 | None | Included | 140 | Good | Heat |
| | | | | | roller |
| Example 13 | Included | None | 140 | Good | Heat |
| | | | | | roller, |
| | | | | | etc. |
| Control | None | None | 212 | No good | Heat |
| example 7 | | | | | roller |
| | | | | | Transport |
| | | | | | system, |
| | | | | | etc. |

The record material surface temperature and image reproducibility when the interference prevention member (baffle board) 23 and the light gathering member 20a were used are examined based on Table 5. Output adjustments of the lamp heater 20 and the heat roller 21 were made so that the temperature on the record material became about 90° C.

In example 11, the baffle board for interference prevention 23 and the light gathering member (unit with reflection plate) 20a of the lamp heater 20 were provided and 12 plates were made consecutively. As a result, the fixing temperature distribution on the record material was uniform and good image reproduction was obtained. The print result using the paper plate was also good. Trouble on the apparatus did not occur.

In example 12, the baffle board for interference prevention 23 was removed from example 11 and 12 plates were made consecutively. As a result, the fixing temperature distribution on the record material was uniform and good image reproduction was obtained. The print result using the paper plate was also good. Trouble on the apparatus did not occur.

In example 13, the light gathering member 20a of the lamp heater 20 was removed from example 11 and 12 plates were made consecutively. As a result, the fixing temperature distribution on the record material was uniform and good image reproduction was obtained. The print result using the paper plate was also good. Trouble on the apparatus did not occur.

In control example 7, both the interference prevention member 23 and the light gathering member 20a of the lamp heater 20 were removed and 12 plates were made consecutively. As a result, the temperature of the heat roller 21 reached 212° C. at the maximum and deformation of the record material and an image defect were observed. The paper plate was used for printing. An image defect such as inconsistencies in density observed in tint occurred.

During the plate making, an unusual noise was produced from the bearing of the heat roller 21 and a rotation failure occurred. In addition, an anomaly also occurred in the transport system.

As described above, the baffle board for interference prevention 23 and the light gathering member 20a of the lamp heater 20 are provided, whereby a structure can be provided for making it possible to make the fixing temperatures uniform, provide printed matter excellent in image reproducibility, and further prevent apparatus trouble from occurring.

TABLE 6

| | | Record material | | | |
|---|---|---|---|---|---|
| | Number of | temperature ° C. | | | Apparatus |
| Experiment | modulation | Top | Rear end | Image | trouble |
| No. | times | portion | portion | quality | part |
| Example 14 | 2 | 94 | 97 | Good | None |
| Example 15 | 1 | 92 | 98 | Good | None |
| Control | 0 | 76 | 95 | No good | None |
| example 8 | | | | | |
| Control | 0 | 96 | 116 | No good | Heat |
| example 9 | | | | | roller |
| | | | | | drive |
| | | | | | section |

The record material surface temperature and image reproducibility when lamp heater output control mechanism according to the invention was provided are examined based on Table 6. Output adjustments of the lamp heater 20 and the heat roller 21 were made.

In example 14, the output control mechanism of the lamp heater 20 was provided, output modulation was conducted twice, and plate making was performed. As a result, the fixing temperature distribution on the record material was uniform and good image reproduction was obtained. Trouble on the apparatus did not occur.

On the other, in example 15, the output control mechanism of the lamp heater 20 was provided, output modulation was conducted once, and plate making was performed. As a result, the uniformity of the fixing temperature distribution on the record material was inferior to that in example 14, but good image reproduction was obtained. The printing result using the paper plate was also good. Trouble on the apparatus did not occur.

On the other hand, in control example 8, the output control mechanism of the lamp heater 20 was not provided, output modulation was not conducted, and plate making was performed. As a result, the fixing temperature distribution on the record material became non-uniform and the temperature lowered in the tip portion. As a result of printing using the paper plate, a fixing failure occurred in the top portion of the fixing (fixing start position) and character chip was observed on the printed matter.

In control example 9, the output control mechanism of the lamp heater 20 was not provided, output modulation was not conducted, only output of the lamp heater 20 is raised, and plate making was performed. As a result, the fixing temperature distribution on the record material remained non-uniform and the temperature rose in the rear end portion. As a result of printing using the paper plate, on the obtained printed matter, hot offset and deformation of the record material (paper) caused by excessive fixing were observed in the rear end portion of the fixing (fixing termination position). Trouble on the apparatus did not occur. When printing was performed consecutively, the temperature in the apparatus rose and an unusual noise was heard from the bearing part of the heat roller.

As described above, the output control mechanism of the lamp heater is provided and output modulation is conducted, whereby a structure can be provided for making it possible to make the fixing temperatures uniform, provide printed matter excellent in image reproducibility, and further prevent apparatus trouble from occurring.

### EXAMPLES 16,17 and 18

A toner jet record apparatus 50 shown in FIG. 5 is made up mainly of a record section 51 and the heat fixing section 11 according to the invention. It also comprises a paper feed cassette 31 for loading record paper P and a paper ejection tray 38 for taking out the paper P. The record section 51 records an image on the paper P inserted from the paper feed cassette 31 and transported by a pair of transport rollers 32. The heat fixing section 11 fixes the image recorded on the paper P. Further, the paper P is sent through a transport roller pair 37 to the paper ejection tray 38.

The record section 51 is made up of a rotatable brush roller 52 comprising a brush for charging toner T, an aperture electrode 53, and a drawing drum 59 having the function of a counter electrode, opposed to the aperture electrode 53 with a predetermined spacing from the aperture electrode 53. The drawing drum 59 is connected to a power supply E2 (minus).

The heat fixing section 11 is made up of a lamp heater 20 having a heat source and a heat roller 21. The paper P is placed on the drawing drum 59 and at the termination of drawing, passes through below the lamp heater 20 and the heat roller 21 and the image can be fixed.

The brush roller 52 is surrounded by a supply roller 54 that can be rotated in accordance with the rotation direction of the brush roller 52, the supply roller 54 for supplying the toner T to the brush roller 52, and a scraping member 55 for repelling the toner T deposited on the brush of the brush roller 52, the supply roller 54 and the scraping member 55 being placed in contact with the brush roller 52. A supply blade 56 for supplying the toner T to the supply roller 54 in uniform thickness is placed in contact with the supply roller 54. The toner T is stored on the supply blade 56. The supply roller 54 and the supply blade 56 are covered with a case K. The aperture electrode 53 is placed above the brush roller 52.

When a known image formation signal and image data are input from an external machine (not shown), the paper P inserted from the paper feed cassette 31 is transported to the record section 51 by the transport rollers 32. In the record section 51, the toner T is pressed against the supply roller 54 by the supply blade 56 and is supported on the surface of the supply roller 54. As the supply roller 54 rotates, the toner T is supplied to the brush roller 52. At this time, the toner T is charged, for example, positively by friction with the brush while the toner T is coming in contact with the supply roller 54 and the brush roller 52. The positively charged toner T is supported on the brush roller 52.

In the vicinity of the aperture electrode 53, the scraping member 55 scrapes the brush of the brush roller 52 with rotation of the brush roller 52. When the brush is restored to the former state by elasticity, a proper amount of the toner T supported on the brush jumps, becomes like a cloud, and is supplied to the aperture electrode 53. At this time, the voltage applied to each control electrode layer of the aperture electrode 53 from a signal source S in response to an input image signal is controlled and the flow of the toner T is modulated.

The modulated and positively charged toner T is attracted to the minus (−) power supply E2 connected to the counter electrode and jets in the direction of the counter electrode. The toner T is sucked to the paper P loaded on the drawing drum 59.

After this, the paper P on which the toner T is deposited is transported to the heat fixing section 11. According to the invention, an image was fixed by heating by heat roller fixing. Before heat roller fixing, the record material was heated and the temperature thereof was raised to 110° C. by the near infrared lamp heater 20. The fixing conditions were as follows: The heat roller temperature was 170° C., the record material transport speed was 13 mm/sec, and the application pressure (nip pressure) of the heat roller 21 to the record material was 1 MPa. The paper P completed in fixing is transported via the transport roller 37 to the paper ejection tray 38 and is ejected.

In the example, the record material is placed on the drawing drum and the record material with the image drawn thereon is ejected, but the configuration of the apparatus is not limited to it. With a transfer drum provided, an image may be drawn on the drawing drum and then may be transferred to paper on the transfer drum and be fixed and the paper may be ejected. To supply the record material, any other than the cassette may be used; for example, the record material P may be supplied with a roll.

TABLE 7

| | | | Maximum | | |
|---|---|---|---|---|---|
| | Baffle board | Lamp heater | arrival | Reproducibility | |
| | for | light | temperature | of | |
| Experiment | interference | gathering | ° C. of heat | post-fixed | Apparatus |
| No. | prevention | member | roller | image | trouble part |
| Example 16 | Included | Included | 170 | Good | None |
| Example 17 | None | Included | 170 | Good | None |
| Example 18 | Included | None | 170 | Good | None |
| Control | None | None | 256 | No good | Heat roller |
| example 10 | | | | | Transport |
| | | | | | system, etc. |

The record material surface temperature and image reproducibility when the interference prevention member and the light gathering member were used are examined based on Table 7. Output adjustments of the lamp heater 20 and the heat roller 21 were made so that the temperature on the record material became about 130° C. at the center in the width direction.

In example 16, baffle board for interference prevention 23 and the light gathering member (unit with reflection plate) 20a of the lamp heater 20 were provided and printing was performed on 25 sheets consecutively. As a result, the fixing temperature distribution on the record material was uniform and good image reproduction was obtained. Trouble on the apparatus did not occur.

In example 17, the baffle board for interference prevention 23 was removed from example 16 and printing was performed on 25 sheets consecutively. As a result, the fixing temperature distribution on the record material was uniform and good image reproduction was obtained. Trouble on the apparatus did not occur.

In example 18, the light gathering member 20a of the lamp heater 20 was removed from example 16 and printing was performed on 25 sheets consecutively. As a result, the fixing temperature distribution on the record material was uniform and good image reproduction was obtained. Trouble on the apparatus did not occur.

In control example 10, both the interference prevention member 23 and the light gathering member 20a of the lamp heater 20 were removed and printing was performed on 25 sheets consecutively. As a result, the temperature of the heat roller 21 reached 256° C. at the maximum and deformation of the record material and an image defect were observed.

During the printing, an unusual noise was produced from the bearing of the heat roller 21 and a rotation failure occurred. In addition, an anomaly also occurred in the transport system.

As described above, the baffle board for interference prevention 23 and the light gathering member 20a of the lamp heater 20 are provided, whereby a structure can be provided for making it possible to make the fixing temperatures uniform, provide printed matter excellent in image reproducibility, and further prevent apparatus trouble from occurring.

### EXAMPLES 19 and 20

The fixing conditions were as follows: The heat roller temperature was 175° C., the record material transport speed was 12.5 mm/sec, and the application pressure (nip pressure) of the heat roller 21 to the record material was 1.2 MPa. Output adjustments of the lamp heater 20 and the heat roller 21 were made so that the temperature on the record material became about 130° C. The paper P completed in fixing is transported via the transport roller 37 to the paper ejection tray 38 and is ejected.

In the example, the record material is placed on the drawing drum and the record material with the image drawn thereon is ejected, but the configuration of the apparatus is not limited to it. With a transfer drum provided, an image may be drawn on the drawing drum and then may be transferred to paper on the transfer drum and be fixed and the paper may be ejected. To supply the record material, any other than the cassette may be used; for example, the record material P may be supplied with a roll.

TABLE 8

| | | Record material temperature | | | |
|---|---|---|---|---|---|
| | Number of | ° C. | | | |
| | modulation | | Rear end | Image | Apparatus |
| Experiment No. | times | Top portion | portion | quality | trouble part |
| Example 19 | 2 | 128 | 131 | Good | None |
| Example 20 | 1 | 125 | 133 | Good | None |
| Control | 0 | 110 | 129 | No good | None |
| example 11 | | | | | |
| Control | 0 | 132 | 153 | No good | Transport |
| example 12 | | | | | system |

The record material surface temperature and image reproducibility when lamp heater output control mechanism according to the invention was provided are examined based on Table 8. Output adjustments of the lamp heater 20 and the heat roller 21 were made and in example 19, the output control mechanism of the lamp heater 20 was provided, output modulation was conducted twice, and printing was performed. As a result, the fixing temperature distribution on the record material was uniform and good image reproduction was obtained. Trouble on the apparatus did not occur.

On the other, in example 20, the output control mechanism of the lamp heater 20 was provided, output modulation was conducted once, and printing was performed. As a result, the uniformity of the fixing temperature distribution on the record material was inferior to that in example 19, but good image reproduction was obtained. The heat roller 21 temperature maintained the setup value and remained at 150° C. Trouble on the apparatus did not occur.

On the other hand, in control example 11, the output control mechanism of the lamp heater 20 was not provided, output modulation was not conducted, and printing was performed. As a result, the fixing temperature distribution on the record material became non-uniform and the temperature lowered in the tip portion. On the obtained printed matter, character chip and patchy image caused by a fixing failure were observed in the top portion of the fixing (fixing start position).

In control example 12, the output control mechanism of the lamp heater 20 was not provided, output modulation was not conducted, only output of the lamp heater 20 is raised, and printing was performed. As a result, the fixing temperature distribution on the record material remained non-uniform and the temperature rose in the rear end portion. On the obtained printed matter, hot offset and deformation of the record material (paper) caused by excessive fixing were observed in the rear end portion of the fixing (fixing termination position). Trouble on the apparatus did not occur. When printing was performed consecutively, the temperature in the apparatus rose and an unusual noise was heard from the bearing part of the heat roller.

As described above, the output control mechanism of the lamp heater is provided and output modulation is conducted, whereby a structure can be provided for making it possible to make the fixing temperatures uniform, provide printed matter excellent in image reproducibility, and further prevent apparatus trouble from occurring.

As described above, according to the invention, there is provided the image formation method for forming an image on a record material, the method comprising at least a record material loading step of loading a record material, an image creating step of creating an image onto the record material, and a heat fixing step of heating and fixing the record material with the image created thereon. The heat fixing step comprises a first fixing step of heating the record material created the image in non-contact and a second fixing step of applying pressure at the same time as heating and a thermal interference prevention member is provided for preventing thermal interference between the first and second fixing steps. A baffle board 23 is used as the thermal interference prevention member and a heat fixing member is provided with a light gathering member 20a. Thus, it is made possible to make uniform fixing temperature of a record material in fixing at high speed and a high-quality image can be formed simply, at low cost, and stably.

As described above, according to the invention, there is provided the image formation method for forming an image on a record material, the method comprising at least a step of placing a record material, an image creating step of creating an image onto the record material, and a heat fixing step of heating and fixing the record material with the image created thereon. The heat fixing step comprises a first fixing step of heating the record material created the image in non-contact and a second fixing step of applying pressure at the same time as heating and output at the heat fixing time is changed once or more in the first fixing step. Thus, there can be provided the image formation method and apparatus for making it possible to make the fixing temperatures uniform, provide printed matter excellent in image reproducibility, and further prevent apparatus trouble from occurring.

What is claimed is:

1. An image formation method for forming an image on a record material, the method comprising:
at least a record material loading step of loading a record material;
an image creating step of creating an image onto the record material; and
a heat fixing step of heating and fixing the record material with the image created thereon, the heat fixing step comprising first fixing step of heating the record material created the image in non-contact and a second fixing step of applying pressure at the same time as heating,
wherein the heat fixing step further comprises a thermal interference prevention member providing step providing a thermal interference prevention member for preventing thermal interference between the first and second fixing steps or an output at the heat fixing time changed once or more in the first fixing step.

2. The image formation method as set forth in claim 1 wherein the thermal interference prevention member is provided for preventing thermal interference between the first and second fixing steps.

3. The image formation method as set forth in claim 2 wherein a baffle board is placed between the first and second fixing steps as the thermal interference prevention member.

4. The image formation method as set forth in claim 2 wherein a heat fixing member used in the first fixing step is provided with a light gathering member for heating and fixing the record material.

5. The image formation method as set forth in claim 3 wherein a heat fixing member used in the first fixing step is provided with a light gathering member for heating and fixing the record material.

6. The image formation method as set forth in claim 1 wherein the output at the heat fixing time is changed once or more in the first fixing step.

7. The image formation method as set forth in claim 6 wherein the output is maximized at the heat fixing time when the heat fixing is started and/or minimized at the heat fixing termination time.

8. An image formation apparatus comprising:
a record material loading unit for loading a record material;
an image creating unit for creating an image onto the record material loaded by the record material loading unit; and
a heat fixing unit for heating and fixing the record material created the image by the image creating unit, the heat fixing unit comprising a first fixing unit for heating the record material created the image in non-contact and a second fixing unit for further applying pressure at the same time as heating the record material heated by the first fixing unit,
wherein a thermal interference prevention unit is provided for preventing thermal interference between the first fixing unit and the second fixing unit or an output control mechanism for changing output at the heat fixing time once or more is provided in the first fixing unit.

9. The image formation apparatus as set forth in claim 8 wherein the thermal interference prevention unit is provided for preventing thermal interference between the first fixing unit and the second fixing unit.

10. The image formation apparatus as set forth in claim 9 wherein a baffle board is placed between the first fixing unit and the second fixing unit as the thermal interference prevention unit.

11. The image formation apparatus as set forth in claim 9 wherein the first fixing unit is a lamp heater and the second fixing unit is a heat roller.

12. The image formation apparatus as set forth in claim 10 wherein the first fixing unit is a lamp heater and the second fixing unit is a heat roller.

13. The image formation apparatus as set forth in claim 9 wherein a light gathering member is provided in the first fixing unit.

14. The image formation apparatus as set forth in claim 10 wherein a light gathering member is provided in the first fixing unit.

15. The image formation apparatus as set forth in claim 11 wherein a light gathering member is provided in the first fixing unit.

16. The image formation apparatus as set forth in claim 12 wherein a light gathering member is provided in the first fixing unit.

17. The image formation apparatus as set forth in claim 8 wherein the output control mechanism for changing output at the heat fixing time once or more is provided in the first fixing unit.

18. The image formation apparatus as set forth in claim 17 wherein the first fixing unit is a lamp heater and the second fixing unit is a heat roller.

19. The image formation apparatus as set forth in claim 17 wherein the output control mechanism for controlling the first fixing unit maximizes the output at the heat fixing time when the heat fixing is started and/or minimizes the output at the heat fixing termination time.

20. The image formation apparatus as set forth in claim 18 wherein the output control mechanism for controlling the first fixing unit maximizes the output at the heat fixing time when the heat fixing is started and/or minimizes the output at the heat fixing termination time.
